(19) United States
(12) Patent Application Publication
(10) Pub. No.: US 2016/0119804 A1
(43) Pub. Date: Apr. 28, 2016

(54) ADAPTIVE CONTROL CHANNEL DETECTION IN WIRELESS COMMUNICATIONS

(71) Applicant: QUALCOMM Incorporated, San Diego, CA (US)

(72) Inventors: Ruhua HE, San Diego, CA (US); Sabit EKIN, San Diego, CA (US); Vijey Bhaskar VIJAYAKUMAR, San Diego, CA (US); Parthasarathy KRISHNAMOORTHY, Hyderabad (IN); Tanmaya ASTHANA, Hyderabad (IN); Galib Asadullah MOHIUDDIN MOHAMMED, San Diego, CA (US); Rashid Ahmed Akbar ATTAR, San Diego, CA (US); Pavan KAIVARAM, San Diego, CA (US); Deqiang CHEN, San Diego, CA (US)

(21) Appl. No.: 14/526,273

(22) Filed: Oct. 28, 2014

(51) Int. Cl. H04W 24/08; H04B 7/08; H04L 5/00; H04W 72/04

(52) U.S. Cl. CPC H04W 24/08; H04W 72/042; H04B 7/0885; H04B 7/0888; H04L 5/0048

(57) ABSTRACT

Aspects described herein relate to adaptive control channel detection in wireless communications. A signal-to-interference-and-noise ratio (SINR) of a signal received by a receiver comprising multiple sub-receivers is measured, wherein the SINR is filtered according to a signal combining technology. Based at least in part on the SINR, it is determined whether to utilize the signal combining technology in combining signals related to a channel received over the multiple sub-receivers. Accordingly, the signals related to the channel received over the multiple sub-receivers can be demodulated using the signal combining technology based on determining to utilize the signal combining technology

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is evolution data optimized (EV-DO), which is based on CDMA2000.

In EV-DO, demodulation of a downlink media access control (MAC) channel is performed using maximal ratio combining (MRC). In the case of a single antenna or low correlation in multipath antenna communications, MRC is adequate for demodulating the MAC channel. As wireless communication systems evolve, however, multipath communications over multiple antenna components are becoming commonplace. In scenarios where high correlation exists between multiple antenna components of a device, MRC demodulation performance degrades due to the larger noise variance resulting from MRC combining of signals received over the multiple antenna components. In other words, the high correlation among the antenna components is not advantageously utilized in MRC algorithms.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with some aspects, a method for adaptive control channel detection in wireless communications is provided. The method includes measuring a signal-to-interference-and-noise ratio (SINR) of a signal received by a receiver comprising multiple sub-receivers, wherein the SINR is filtered according to a signal combining technology, determining, based at least in part on the SINR, whether to utilize the signal combining technology in combining signals related to a channel received over the multiple sub-receivers, and demodulating the signals related to the channel received over the multiple sub-receivers using the signal combining technology based on determining to utilize the signal combining technology.

In accordance with additional aspects, an apparatus for adaptive control channel detection in wireless communications is provided. The apparatus includes a SINR measuring component configured to measure a SINR of a signal received by a receiver comprising multiple sub-receivers, wherein the SINR is filtered according to a signal combining technology, a signal combining component configured to determine, based at least in part on the SINR, whether to utilize the signal combining technology in combining signals related to a channel received over the multiple sub-receivers, and a channel demodulating component configured to demodulate the signals related to the channel received over the multiple sub-receivers using the signal combining technology based on determining to utilize the signal combining technology.

In accordance with further aspects, another apparatus for adaptive control channel detection in wireless communications. The apparatus includes means for measuring a SINR of a signal received by a receiver comprising multiple sub-receivers, wherein the SINR is filtered according to a signal combining technology, means for determining, based at least in part on the SINR, whether to utilize the signal combining technology in combining signals related to a channel received over the multiple sub-receivers, and means for demodulating the signals related to the channel received over the multiple sub-receivers using the signal combining technology based on determining to utilize the signal combining technology.

Still in accordance with additional aspects, a non-transitory computer-readable medium storing computer executable code for adaptive control channel detection is provided. The computer executable code includes code executable to measure a SINR of a signal received by a receiver comprising multiple sub-receivers, wherein the SINR is filtered according to a signal combining technology, code executable to determine, based at least in part on the SINR, whether to utilize the signal combining technology in combining signals related to a channel received over the multiple sub-receivers, and code executable to demodulate the signals related to the channel received over the multiple sub-receivers using the signal combining technology based on determining to utilize the signal combining technology.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless communications system according to aspects described herein;

FIG. 2 is a flow diagram comprising a plurality of functional blocks representing an example methodology aspects described herein;

FIG. 3 is a block diagram illustrating an example receiver or related sub-receiver according to aspects described herein;

FIG. 4 is a diagram illustrating an example of a hardware implementation for an apparatus employing a processing system;

FIG. 5 is a block diagram conceptually illustrating an example of a telecommunications system;

FIG. 6 is a diagram illustrating an example of an access network;

FIG. 7 is a diagram illustrating an example of a radio protocol architecture for the user and control plane; and

FIG. 8 is a diagram illustrating an example of an evolved Node B and user equipment in an access network.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Described herein are various aspects related to determining a signal combining technology to utilize in demodulating control channels in wireless communications. For example, minimum mean squared error (MMSE) diversity combining can be used to cancel correlated noise or interference at least in high antenna correlation scenarios to result in more successful control channel demodulation. In an example, a filtered MMSE signal-to-interference-and-noise-ratio (SINR) at a sub-receiver or finger (e.g., of a rake receiver) can be measured to determine whether to utilize MMSE to demodulate a control channel. For instance, the filtered MMSE SINR may be compared to a SINR filtered for another signal combining technology, such as antenna selection combining, or other combining (e.g., to determine whether the difference is within a threshold), in determining whether to utilize MMSE demodulation, antenna selection combining, or the other combining.

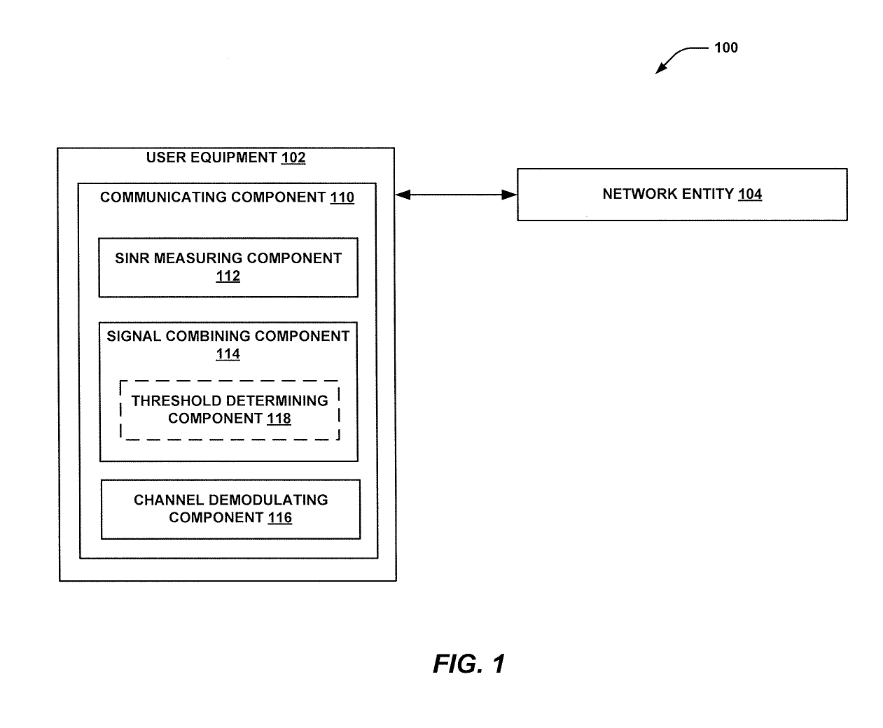

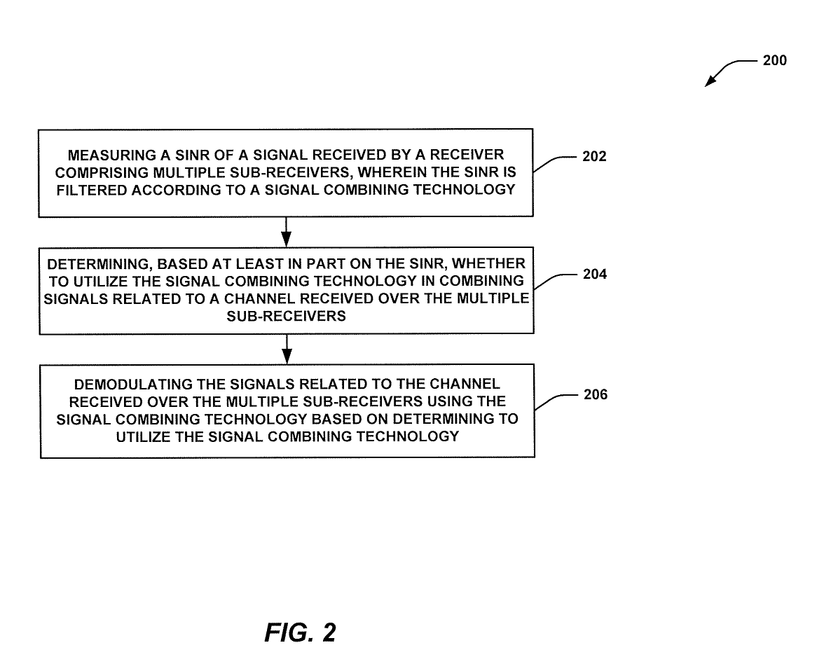

Referring to FIGS. 1 and 2, aspects are depicted with reference to one or more components and one or more methods that may perform the actions or functions described herein. In an aspect, the term “component” as used herein may be one of the parts that make up a system, may be hardware or software or some combination thereof, and may be divided into other components. Although the operations described below in FIG. 2 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

FIG. 1 is a schematic diagram illustrating a system 100 for wireless communication, according to an example configuration. System 100 includes a user equipment (UE) 102 that communicates with a network entity 104 in one or more wireless networks. It is to be appreciated that multiple UEs 102 can communicate with a network entity 104 and/or UE 102 can communicate with multiple network entities 104 in some network configurations. Moreover, UE 102 and network entity 104 can communicate over a single or multiple carriers, using a single or multiple antennas, etc., as described further herein, to facilitate improved throughput, functionality, reliability, etc.

According to an example, UE 102 includes a communicating component 110 for receiving, demodulating, and/or processing signals from one or more network entities 104. Communicating component 110 can include a SINR measuring component 112 for determining SINR or other measure of quality of a received signal, which can also be filtered according to one or more types of signal combining technology (e.g., MMSE diversity combining, antenna selection combining, etc.). Communicating component 110 can also include a signal combining component 114 for determining a signal combining technology to use in combining signals from network entity 104 for demodulation, where the determining can be based at least in part on comparing one or more of the filtered SINRs of the received signal, and a channel demodulating component 116 for demodulating communications from network entity 104 according to the determined signal combining technology. In addition, signal combining component 114 can include a threshold determining component 118 for determining one or more thresholds for determining the signal combining technology.

UE 102 may comprise any type of mobile device, such as, but not limited to, a smartphone, cellular telephone, mobile phone, laptop computer, tablet computer, or other portable networked device that can be a standalone device, tethered to another device (e.g., a modem connected to a computer), a watch, a personal digital assistant, a personal monitoring device, a machine monitoring device, a machine to machine communication device, and/or substantially any device that can communicate in a wireless network. In addition, UE 102 may also be referred to by those skilled in the art as a mobile station, a subscriber station, a mobile unit, a subscriber unit, a wireless unit, a remote unit, a mobile device, a mobile communications device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, UE 102 may be small and light enough to be considered portable and may be configured to communicate wirelessly via an over-the-air (OTA) communication link using one or more OTA communication protocols described herein. Additionally, in some examples, UE 102 may be configured to facilitate communication on multiple separate networks via multiple separate subscriptions, multiple radio links, and/or the like.

Furthermore, network entity 104 may comprise one or more of any type of network module, such as an access point, a macro cell, including a base station (BS), node B, eNodeB (eNB), a relay, a peer-to-peer device, an authentication, authorization and accounting (AAA) server, a mobile switching center (MSC), a mobility management entity (MME), a radio network controller (RNC), a small cell, etc. As used herein, the term “small cell” may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a BS, an access point, a femto node, a femtocell, a pico node, a micro node, a Node B, eNB, home Node B (HNB) or home evolved Node B (HeNB). Therefore, the term “small cell,” as used herein, refers to a relatively low transmit power and/or a relatively small coverage area cell as compared to a macro cell. Additionally, network entity 104 may communicate with one another and/or with one or more other network entities of wireless and/or core networks

Additionally, system 100 may include any network type, such as, but not limited to, wide-area networks (WAN), wireless networks (e.g. 802.11 or cellular network, such as Global System for Mobile Communications (GSM) or its derivatives, etc.), the Public Switched Telephone Network (PSTN) network, ad hoc networks, personal area networks (e.g. Bluetooth®) or other combinations or permutations of network protocols and network types. Such network(s) may include a single local area network (LAN) or wide-area network (WAN), or combinations of LANs or WANs, such as the Internet. Such networks may comprise a Wideband Code Division Multiple Access (W-CDMA) system, and may communicate with one or more UEs 102 according to this standard. As those skilled in the art will readily appreciate, various aspects described herein may be extended to other telecommunication systems, network architectures and communication standards. By way of example, various aspects may be extended to other Universal Mobile Telecommunications System (UMTS) systems such as Time Division Synchronous Code Division Multiple Access (TD-SCDMA), High Speed Downlink Packet Access (HSDPA), High Speed Uplink Packet Access (HSUPA), High Speed Packet Access Plus (HSPA+) and Time-Division CDMA (TD-CDMA). Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), Institute of Electrical and Electronics Engineers (IEEE) 802.11 (Wi-Fi), IEEE 802.16 (WiMAX®), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g., UEs 102, network entity 104) may be coupled to a core network via one or more wired or wireless connections.

As used herein, the term MRC is understood to include a mechanism for signal combining where signals received over multiple sub-receivers are weighed with respect to their signal-to-noise ratio (SNR) or SINR, and then summed to yield a combined signal.

As used herein, the term selection combining is understood to include a mechanism for signal combining where a strongest signal of the signals received over multiple sub-receivers is selected as the combined signal.

As used herein, the term MMSE diversity combining is understood to include a mechanism for signal combining where a mean squared error estimate of the signals received over multiple sub-receivers is determined as the combined signal.

As used herein, the term signal combining technology is understood to include possible types of signal combining, such as antenna selection combining, MMSE diversity combining, etc.

FIG. 2 illustrates a method 200 for determining a demodulation type to use for wireless communications based at least in part on comparing filtered SINRs of a received signal. Method 200 includes, at Block 202, measuring a SINR of a signal received by a receiver comprising multiple sub-receivers, wherein the SINR is filtered according to a signal combining technology. SINR measuring component 112 (FIG. 1) can measure the SINR of a signal received over the receiver comprising the multiple sub-receivers, wherein the SINR is filtered according to a signal combining technology. For example, SINR measuring component 112 can pass an instantaneous SINR of the signal through a first-order low pass filter (not shown) to obtain the filtered SINR. In one example, the signal can include a pilot signal transmitted by the network entity 104. For example, UE 102 can include a multipath antenna (not shown) and communicating component 110 can include a rake receiver with multiple sub-receivers (also referred to herein as “fingers”), each of which is operable to receive and decode a signal from network entity 104 over a component of the multipath antenna.

Using a multipath antenna and multiple sub-receivers, in this regard for example, allows for achieving diversity in receiving the signals from network entity 104, which can improve successfully decoding and/or demodulation of the signals, as each finger may receive a slightly different interpretation of the signal over the multipath antenna. For example, if one of the fingers is experiencing an unfavorable condition (e.g., deep fade) due to high interference or other environmental factors, another finger may not experience the condition, or at least not the same level of the condition. Thus, in this example, at least one finger may receive a clearer interpretation of the signal than another finger. In this regard, signal combining component 114 can combine signals received over the fingers using one or more signal combining technologies, as described below, to determine a combined signal for demodulation. Different signal combining technologies, however, may be advantageous in different scenarios. In addition, though SINR is referred to throughout, it is to be appreciated that the functionality described herein can be applied to other signal measurements, such as SNR.

Thus, method 200 can include, at Block 204, determining, based at least in part on the SINR, whether to utilize the signal combining technology in combining signals related to a channel received over the multiple sub-receivers. Signal combining component 114 may determine, based at least in part on the SINR, whether to utilize the signal combining technology in combining signals related to a channel received over the multiple sub-receivers. For example, signal combining component 114 may determine whether to use the signal combining technology to combine signals from communications received from network entity 104 based at least in part on comparing the filtered SINR to a threshold SINR, and if the filtered SINR does not achieve the threshold SINR, signal combining component 114 can determine to utilize a different type of signal combining.

In another example, signal combining component 114 may compare the filtered SINR to another SINR filtered according to another signal combining technology. In this example, signal combining component 114 may determine a difference between the filtered SINR and the another filtered SINR of the another signal combining technology, and may accordingly determine whether the difference achieves a threshold. If the difference achieves the threshold, for example, signal combining component 114 may determine to use the signal combining technology for signals related to the channel received over the multiple sub-receivers when demodulating the signals instead of the another signal combining technology. If the difference does not achieve the threshold, for example, signal combining component 114 may determine to use the another signal combining technology for signals related to the channel received over the multiple sub-receivers when demodulating the signals.

In addition, for example, it is to be appreciated that threshold determining component 118 may adaptively determine the threshold or threshold difference, as described above, by obtaining the threshold or threshold difference from a configuration stored in or received by communicating component 110 or other component of UE 102, a configuration provisioned to the UE 102 by a network entity (e.g., network entity 104 or other entity), etc. In another example, threshold determining component 118 may determine the threshold or threshold difference based at least in part on previous thresholds or threshold differences used by signal combining component 114 to determine a signal combining technology along with corresponding resulting SINRs, demodulation success rates, and/or the like.

Method 200 further includes, at Block 206, demodulating the signals related to the channel received over the multiple sub-receivers using the signal combining technology based on determining to utilize the signal combining technology. Channel demodulating component 116 can demodulate the signals related to the channel received over the multiple sub-receivers using the signal combining technology based on determining to utilize the signal combining technology. For example, channel demodulating component 116 can combine signals received from network entity 104 related to the channel by using the signal combining technology where signal combining component 114 determines to utilize the signal combining technology based on comparing the filtered SINR(s) to a threshold or threshold difference, as described above. Combining the signals can be performed for locked fingers of the antenna included in communicating component 110. For instance, locked fingers can refer to fingers (or sub-receivers) that have a filtered received signal strength indicator (RSSI) over a threshold level. In one example, once the finger achieves an RSSI of a first threshold, it can become a locked finger until the RSSI falls below a second threshold, after which the finger is unlocked and must again achieve the first threshold RSSI to become locked. In addition, combining the signals, for example, can include signal combining component 114 applying weights to the signal that can be specific to MMSE or selection combining such that the appropriate weights are applied based on the signal combining technology selected.

In a specific example, the signal combining technology may correspond to MMSE diversity combining. Thus, for example, SINR measuring component 112 can measure a MMSE filtered SINR of the received signal, and signal combining component 114 can determine whether to utilize MMSE diversity combining to combine signals related to a channel based on comparing the filtered SINR to a threshold. In one example, SINR measuring component 112 can also measure a SINR filtered for antenna selection combining, and signal combining component 114 can compare the MMSE filtered SINR to the SINR filtered for antenna selection combining to determine a difference. If the difference achieves a threshold, as described, signal combining component 114 can determine to utilize MMSE diversity combining for signals related to the channel instead of antenna selection combining. If, however, the difference does not achieve the threshold, signal combining component 114 can determine to utilize antenna selection combining to combine signals related to the channel instead of MMSE diversity combining.

In another example, the channel that is demodulated may correspond to a control channel, such as a media access control (MAC) channel in EV-DO, which may carry controls such as reverse power control (RPC), data rate control (DRC) lock, reverse activity (RA), automatic repeat/request (ARQ), and/or similar channels. Typically antenna selection combining is used to combine the control channel signals received over multiple sub-receivers in demodulating the channel. However, as antenna correlation in the multipath antenna of UE 102 increases, antenna selection combining performance degrades due to larger noise variance among the sub-receivers. Accordingly, communicating component 110 can be configured to utilize antenna selection combining in some scenarios, but to use MMSE diversity combining in other scenarios for demodulating the MAC channel, as described above. For example, MMSE diversity combining may be capable of canceling correlated noise or interference among sub-receivers, such to result in higher SINR than antenna selection combining. In other words, the combined SINR among sub-receivers (e.g., using MMSE diversity combining) is often larger than the sum of individual SINR values (e.g., using antenna selection combining), which can improve MAC decoding even when antenna correlation at the multipath antenna is high.

In one example, where signal combining component 114 determines whether to utilize MMSE diversity combining for combining signals related to the MAC channel based on a threshold difference, the threshold difference in SINR filtered for MMSE and another SINR filtered for antenna selection combining may be a parameter configured in UE 102 (e.g., by a stored configuration or network configuration), a parameter computed by the UE 102 based on previous signal combining results, and/or the like. In one example, threshold determining component 118 can determine the threshold difference based at least in part on a MMSE combined noise standard deviation that is an adaptive function of the antenna correlation. For example, threshold determining component 118 may set the threshold difference such to achieve a desired false alarm rate for hybrid ARQ (H-ARQ) and/or a miss detection rate for last ARQ (L-ARQ)/packet ARQ (P-ARQ) channels with different antenna correlation. The HARQ false alarm rate can refer to a rate at which the UE 102 detects HARQ NACK received from one or more network entities (e.g., network entity 104) as a HARQ ACK. The L-ARQ/P-ARQ miss detection rate can refer to a rate at which the UE 102 detects a L-ARQ/P-ARQ ACK received from one or more network entities (e.g., network entity 104) as a L-ARQ/P-ARQ NACK.

In addition, in another example, communicating component 110 can determine if antenna diversity is enabled in the multipath antenna, and signal combining component 114 can determine whether to use MMSE diversity combining or antenna selection combining (and/or whether to measure the filtered SINR in the first place) based on whether antenna diversity is enabled. If antenna diversity is not enabled, for example, signal combining component 114 may determine to use antenna selection combining in demodulating the MAC channel without SINR measuring component 112 measuring SINR at all.

In addition, channel demodulating component 116 can determine a value for the demodulated channel based at least in part on comparing the combined signal to one or more detection thresholds. For example, the detection thresholds can be configured for determining a control value for certain MAC channels where the combined signal value can map to possible control values based on the detection thresholds. In one example, the detection thresholds may be different based on the signal combining technology utilized (e.g., because MMSE diversity combining may result in signals of higher accuracy). Thus, signal combining component 114 may additionally inform the channel demodulating component 116 of the signal combining technology determined and used to combine the signals related to the channel, and channel demodulating component 116 can determine the detection thresholds based at least in part on the signal combining technology.

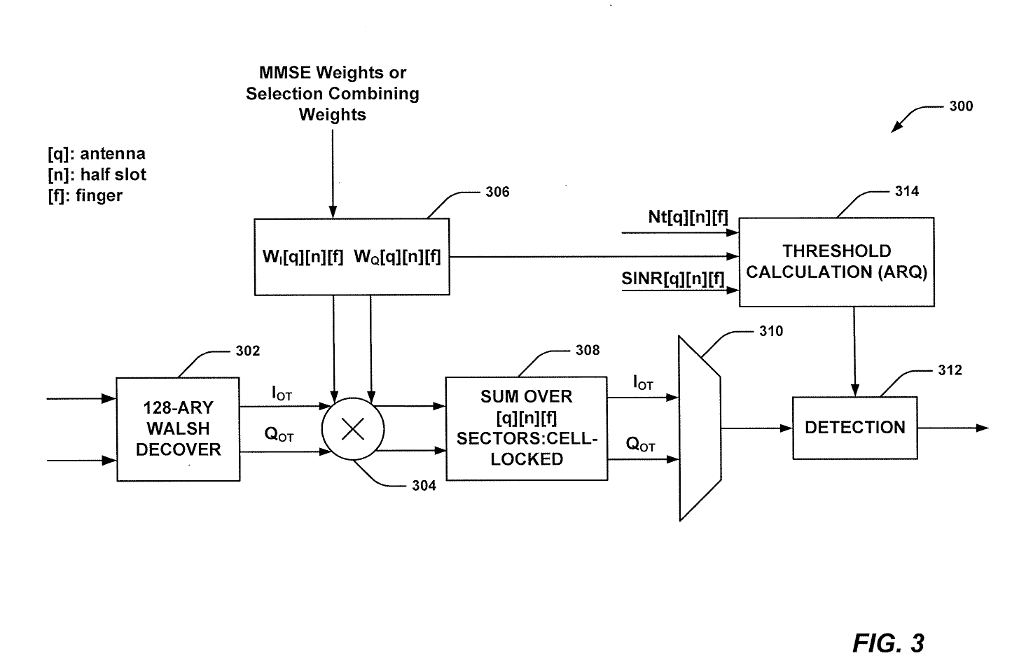

FIG. 3 illustrates an example receiver 300 over which a pilot signal is received and a determined signal combining technology is used for communications. As described, at least a portion of receiver 300 can be included in communicating component 110, and/or can be a sub-receiver of a receiver included in communicating component 110. In addition, as described below, receiver 300 can operate with other components of communicating component 110 (e.g., signal combining component 114 to determine whether MMSE or selection combining is selected). Receiver 300 includes a 128-ary Walsh decover 302 that receives signals over an I and Q branch of an antenna (or related antenna component) and decovers a 128-ary Walsh sequence from the branches (e.g., with respect to a MAC index of the UE 102). Receiver 300 also includes a complex dot product multiplier 304 that that multiplies the decovered outputs from the 128-ary Walsh decover 302 by a complex conjugate of at least one of a MMSE weight or an antenna selection combining weight, shown at 306, for each antenna associated with a pilot burst in a given half slot and combined over the receive antennas. For example, the weight to apply can be selected based at least in part on comparing the filtered SINR for MMSE diversity combining and the filtered SINR for antenna selection combining, comparing a difference in the SINRs to a threshold, etc., as described above (e.g., as determined by signal combining component 114). Thus, for example, the weights applied at 306 can be selected based on whether MMSE or selection combining is selected by signal combining component 114, as described with reference to FIGS. 1 and 2 above.

The multiplier 304 output can be repetition summed by a summer 308 over the two half slots and over all sub-receivers associated with each cell-locked cell in a sector based on the combined cell SINR. The output of summer 308 can be a pair of real numbers I_{OT} and Q_{OT}, which are provided to a function 310 to produce an output based on the channel being demodulated. The output is provided to a detection function 312 to detect a control value for a control element on the MAC channel. In this specific example, detection function 312 detects an ARQ value from the signal output. A threshold calculation function 314 determines a threshold for detecting an ARQ value from the received signals based at least in part on the inputs provided thereto, including an estimated noise (Nt[q][n][f]), an instantaneous SINR of either MMSE or selection combining (SINR[q][n][f]), and weights applied at 306, where [q] is the antenna index, [n] is the half slot index, and [f] is the finger index. It is to be appreciated that the threshold calculation function 314 can be generic to combining methods (e.g., MMSE or selection combining) in this regard, which means that the inputs to the function 314, which can include Nt[q][n][f], SINR[q][n][f], the MRC or MMSE weight, etc., can differ based on whether MMSE or antenna selection combining is used.

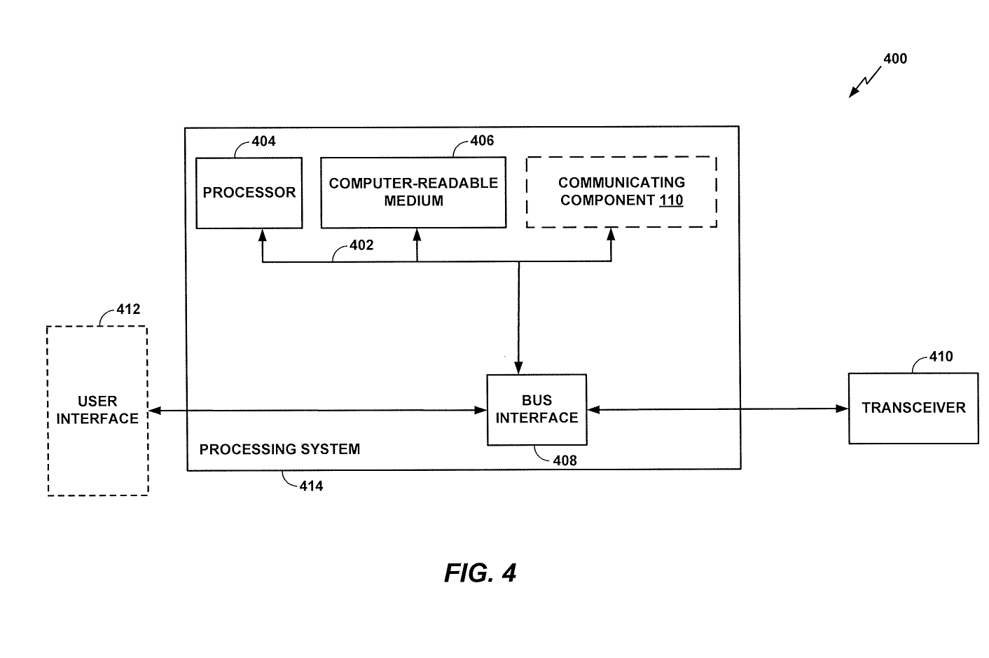

FIG. 4 is a conceptual diagram illustrating an example of a hardware implementation for an apparatus 400 employing a processing system 414 for allocating transmission power, as described herein. In some examples, the processing system 414 may comprise a UE or a component of a UE (e.g., UE 102 of FIG. 1, etc.), a network entity or a component thereof (e.g., network entity 104 of FIG. 1, etc.), and/or the like. For example, communicating component 110 may be implemented in hardware as one or more processor modules of processor 404, or in software as computer executable code stored in computer-readable medium 406, which is executable by processor 404, as described further below. In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, computer-readable media, represented generally by the computer-readable medium 406, communicating component 110, components thereof, etc. (FIG. 1), which may be configured to carry out one or more methods or procedures described herein.

The bus 402 may also link various other circuits such as timing sources, peripherals, voltage regulators, and power management circuits, which are well known in the art. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406. The software, when executed by the processor 404, causes the processing system 414 to perform the various functions described infra for any particular apparatus. The computer-readable medium 406 may also be used for storing data that is manipulated by the processor 404 when executing software.

In an aspect, processor 404, computer-readable medium 406, or a combination of both may be configured or otherwise specially programmed to perform the functionality of the communicating component 110, components thereof, etc. (FIG. 1), or various other components described herein. For example, processor 404, computer-readable medium 406, or a combination of both may be configured or otherwise specially programmed to perform the functionality of the communicating component 110, components thereof, etc. described herein (e.g., the method 200 in FIG. 2, etc.), and/or the like.

The various concepts presented herein may be implemented across a broad variety of telecommunication systems, network architectures, and communication standards.

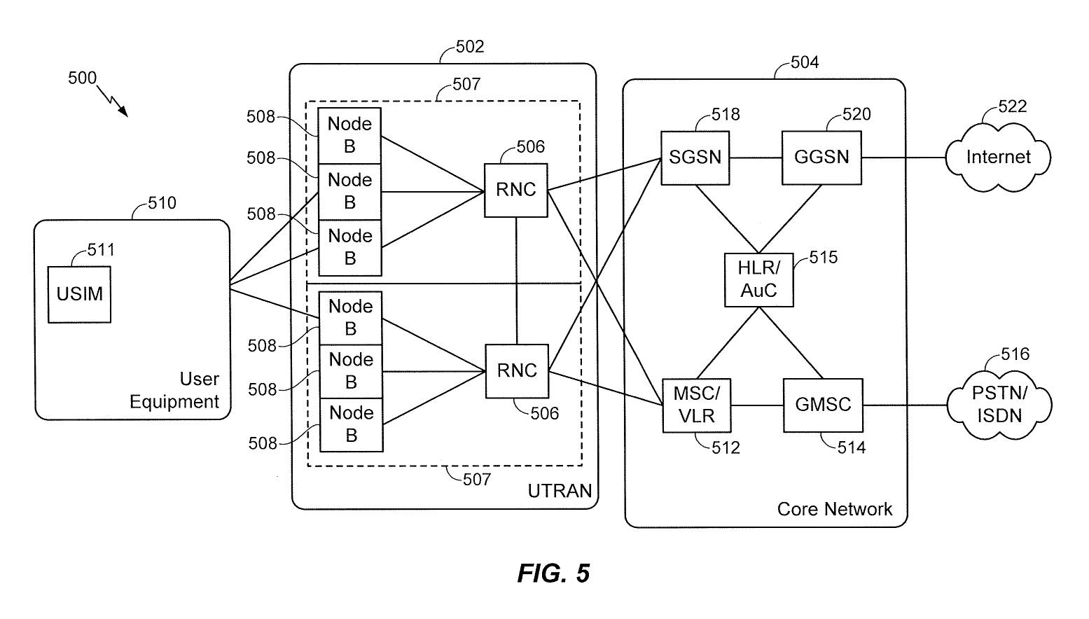

Referring to FIG. 5, by way of example and without limitation, the aspects presented herein are presented with reference to a UMTS system 500 employing a W-CDMA air interface and operable for allocating transmission power as described herein. A UMTS network includes three interacting domains: a Core Network (CN) 504, a UMTS Terrestrial Radio Access Network (UTRAN) 502, and User Equipment (UE) 510. In this example, the UTRAN 502 provides various wireless services including telephony, video, data, messaging, broadcasts, and/or other services. For example, UE 510 can correspond to one or more UEs described herein (such as UE 102, FIG. 1) and/or can include one or more components thereof, including communicating component 110. The UTRAN 502 may include a plurality of Radio Network Subsystems (RNSs) such as an RNS 507, each controlled by a respective Radio Network Controller (RNC) such as an RNC 506. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a Node B 508 may be considered as including a physical (PHY) layer and a medium access control (MAC) layer. Further, communication between a UE 510 and an RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3, as described in further detail with respect to FIG. 5. In addition, the Node B 508 and/or RNC 506 can be a network entity described herein (e.g., network entity 104 in FIG. 1).

The geographic region covered by the RNS 507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each RNS 507; however, the RNSs 507 may include any number of wireless Node Bs. The Node Bs 508 provide wireless access points to a CN 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. For illustrative purposes, one UE 510 is shown in communication with a number of the Node Bs 508. The DL, also called the forward link, refers to the communication link from a Node B 508 to a UE 510, and the UL, also called the reverse link, refers to the communication link from a UE 510 to a Node B 508.

The CN 504 interfaces with one or more access networks, such as the UTRAN 502.

As shown, the CN 504 is a GSM core network. However, as those skilled in the art will recognize, the various concepts presented herein may be implemented in a RAN, or other suitable access network, to provide UEs with access to types of CNs other than GSM networks.

The CN 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a VLR that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The CN 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 508 and a UE 510. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the HS-DPCCH.

Among these physical channels, the HS-DPCCH carries the HARQ ACK/NACK signaling on the uplink to indicate whether a corresponding packet transmission was decoded successfully. That is, with respect to the downlink, the UE 510 provides feedback to the node B 508 over the HS-DPCCH to indicate whether it correctly decoded a packet on the downlink.

HS-DPCCH further includes feedback signaling from the UE 510 to assist the node B 508 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect, the node B 508 and/or the UE 510 may have multiple antennas supporting MIMO technology. The use of MIMO technology enables the node B 508 to exploit the spatial domain to support spatial multiplexing, beamforming, and transmit diversity.

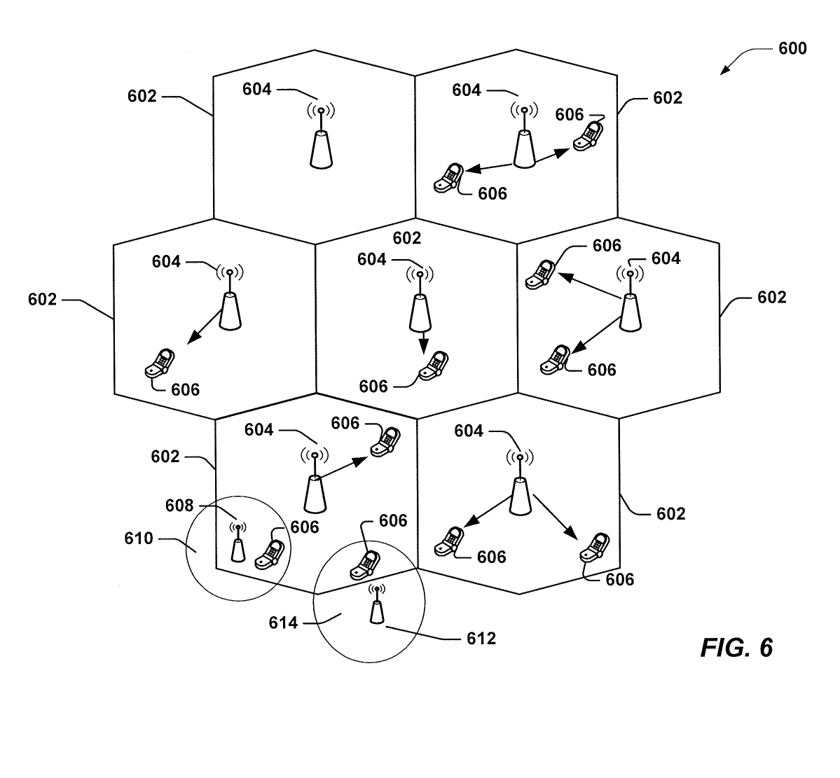

FIG. 6 is a diagram illustrating an example of an access network, including one or more UEs operable to allocate transmission power, as described herein, such as UE 102 including communicating component 110. In this example, the access network 600 is divided into a number of cellular regions (cells) 602. One or more lower power class Node Bs 608, 612 may have cellular regions 610, 614, respectively, that overlap with one or more of the cells 602. The lower power class Node Bs 608, 612 may be small cells (e.g., home Node Bs (HNBs)). A higher power class or macro Node B 604 is assigned to a cell 602 and is configured to provide an access point in a UTRAN 502 to a core network 504 (FIG. 5) for all the UEs 606 in the cell 602. There is no centralized controller in this example of an access network 600, but a centralized controller may be used in alternative configurations. The Node B 604 is responsible for all radio related functions including radio bearer control, admission control, mobility control, scheduling, security, and connectivity to one or more components of a core network 504, etc. In an aspect, one or more of the Node Bs 604, 608, 612 may represent an example of network entity 104 of FIG. 1.

The modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The Node B 604 may have multiple antennas supporting multiple-input, multiple output (MIMO) technology. The use of MIMO technology enables the Node B 604 to exploit the spatial domain to support spatial multiplexing, beamforming, and transmit diversity.

Spatial multiplexing may be used to transmit different streams of data simultaneously on the same frequency. The data steams may be transmitted to a single UE 606 to increase the data rate or to multiple UEs 606 to increase the overall system capacity. This is achieved by spatially precoding each data stream and then transmitting each spatially precoded stream through a different transmit antenna on the downlink. The spatially precoded data streams arrive at the UE(s) 606 with different spatial signatures, which enables each of the UE(s) 606 to recover the one or more data streams destined for that UE 606. On the uplink, each UE 606 transmits a spatially precoded data stream, which enables the Node B 604 to identify the source of each spatially precoded data stream. In an aspect, UE 606 may represent an example of UE 102, and may include one or more of its various components described in FIG. 1.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PARR).

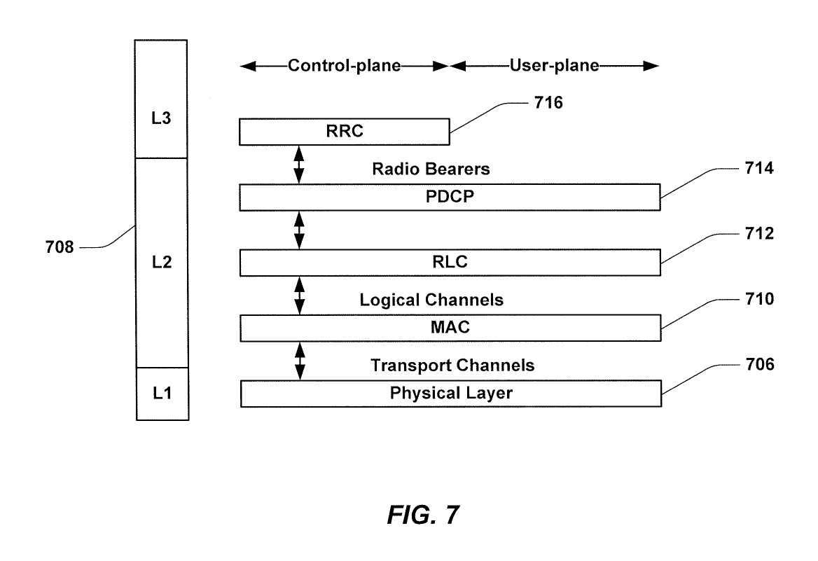

Turning to FIG. 7, the radio protocol architecture for a UE (e.g., UE 102 with one or more of its various components as described in FIG. 1) and an Node B (e.g., network entity 104 of FIG. 1) is shown with three layers: Layer 1, Layer 2, and Layer 3. Layer 1 is the lowest layer and implements various physical layer signal processing functions. Layer 1 will be referred to herein as the physical layer 706. Layer 2 (L2 layer) 708 is above the physical layer 706 and is responsible for the link between the UE and Node B over the physical layer 706.

In the user plane, the L2 layer 708 includes a media access control (MAC) sublayer 710, a radio link control (RLC) sublayer 712, and a packet data convergence protocol (PDCP) 714 sublayer, which are terminated at the Node B on the network side. Although not shown, the UE may have several upper layers above the L2 layer 708 including a network layer (e.g., IP layer) that is terminated one or more components of core network 504 (FIG. 5) on the network side, and an application layer that is terminated at the other end of the connection (e.g., far end UE, server, etc.).

The PDCP sublayer 714 provides multiplexing between different radio bearers and logical channels. The PDCP sublayer 714 also provides header compression for upper layer data packets to reduce radio transmission overhead, security by ciphering the data packets, and handover support for UEs between Node Bs. The RLC sublayer 712 provides segmentation and reassembly of upper layer data packets, retransmission of lost data packets, and reordering of data packets to compensate for out-of-order reception due to hybrid automatic repeat request (HARQ). The MAC sublayer 710 provides multiplexing between logical and transport channels. The MAC sublayer 710 is also responsible for allocating the various radio resources (e.g., resource blocks) in one cell among the UEs. The MAC sublayer 710 is also responsible for HARQ operations.

In the control plane, the radio protocol architecture for the UE and Node B is substantially the same for the physical layer 706 and the L2 layer 708 with the exception that there is no header compression function for the control plane. The control plane also includes a radio resource control (RRC) sublayer 716 in Layer 3. The RRC sublayer 716 is responsible for obtaining radio resources (i.e., radio bearers) and for configuring the lower layers using RRC signaling between the Node B and the UE.

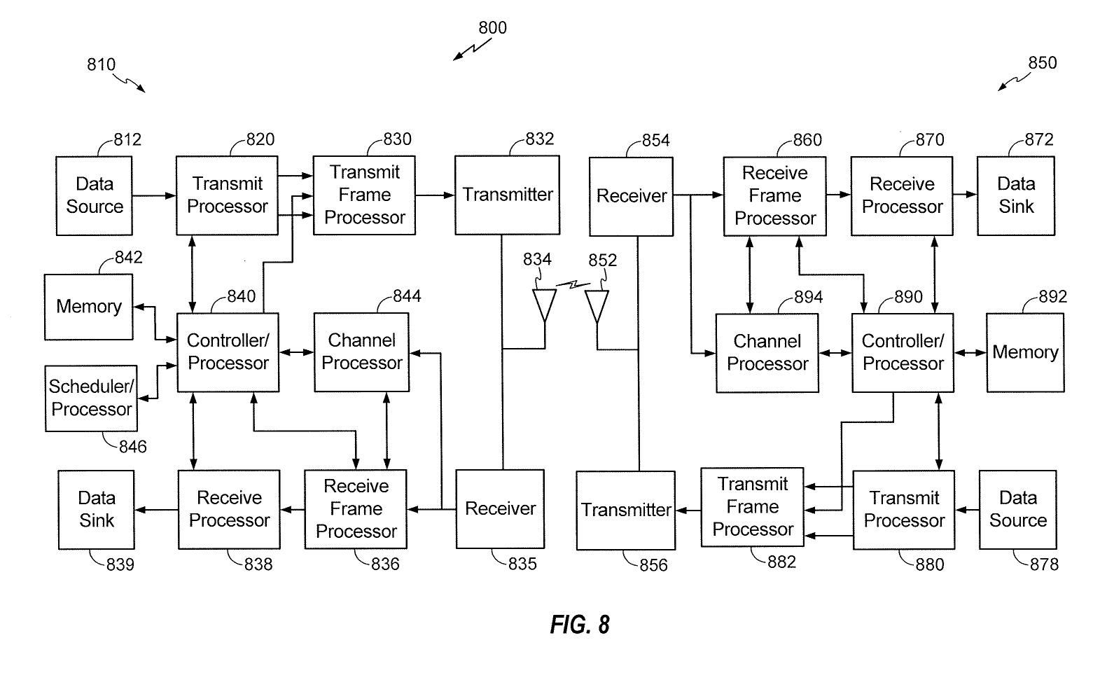

FIG. 8 is a block diagram of a Node B 810 in communication with a UE 850, where the Node B 810 may be or may include network entity 104 (FIG. 1), Node B 508 (FIG. 5), etc., and the UE 850 may be or may include UE 102 (FIG. 1) including components thereof, such as communicating component 110, components thereof, etc., UE 510 (FIG. 5), etc. For example, communicating component 110 (FIG. 1) may include or be receiver 854, receive frame processor 860, receive processor 870, controller processor 890, channel processor 894, etc. In addition, for example, memory 872 may store instructions for executing functions described above with respect to communicating component 110, method 200 (FIG. 2), etc. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively (e.g., to configure and/or execute functions described herein). A scheduler/processor 846 at the Node B 810 may be used to allocate resources to the UEs and schedule downlink and/or uplink transmissions for the UE.

Several aspects of a telecommunications system have been presented with reference to a W-CDMA system. As those skilled in the art will readily appreciate, various aspects described herein may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects described herein, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented herein depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods or methodologies described herein may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A method for adaptive control channel detection in wireless communications, comprising:
measuring a signal-to-interference-and-noise ratio (SINR) of a signal received by a receiver comprising multiple sub-receivers, wherein the SINR is filtered according to a signal combining technology;
determining, based at least in part on the SINR, whether to utilize the signal combining technology in combining subsequently received signals related to a channel received over the multiple sub-receivers; and
demodulating the subsequently received signals related to the channel received over the multiple sub-receivers using the signal combining technology based on determining to utilize the signal combining technology.

2. The method of claim 1, further comprising measuring another SINR of the signal, wherein the another SINR is filtered for another selection combining technology, wherein the determining is based at least in part on comparing the SINR to the another SINR to determine a difference relative to a threshold.

3. The method of claim 2, wherein the signal combining technology is minimum mean squared error (MMSE) diversity combining, and the another signal combining technology is antenna selection combining.

4. The method of claim 2, further comprising adaptively determining the threshold based at least in part on a minimum mean squared error (MMSE) combined noise standard deviation, wherein the signal combining technology is MMSE diversity combining.

5. The method of claim 1, further comprising detecting a control value for the channel at least in part by comparing one or more detection thresholds to the channel, wherein the one or more detection thresholds are determined based at least in part on the determining whether to utilize the signal combining technology combining the subsequently received signals.

6. The method of claim 1, wherein the measuring is performed based at least in part on determining whether antenna diversity is enabled at a multipath antenna over which the signal is received.

7. The method of claim 1, wherein the signal is a pilot signal.

8. The method of claim 1, wherein the channel is a media access control channel.

9. An apparatus for adaptive control channel detection in wireless communications, comprising:
a signal-to-interference-and-noise ratio (SINR) measuring component configured to measure a SINR of a signal received by a receiver comprising multiple sub-receivers, wherein the SINR is filtered according to a signal combining technology;
a signal combining component configured to determine, based at least in part on the SINR, whether to utilize the signal combining technology in combining subsequently received signals related to a channel received over the multiple sub-receivers; and
a channel demodulating component configured to demodulate the subsequently received signals related to the channel received over the multiple sub-receivers using the signal combining technology based on determining to utilize the signal combining technology.

10. The apparatus of claim 9, wherein the SINR measuring component is further configured to measure another SINR of the signal, wherein the another SINR is filtered for another selection combining technology, and wherein the signal combining component is further configured to determine whether to utilize the signal combining technology based at least in part on comparing the SINR to the another SINR to determine a difference relative to a threshold.

11. The apparatus of claim 10, wherein the signal combining technology is minimum mean squared error (MMSE) diversity combining, and the another signal combining technology is antenna selection combining.

12. The apparatus of claim 10, further comprising a threshold determining component configured to adaptively determine the threshold based at least in part on a minimum mean squared error (MMSE) combined noise standard deviation, wherein the signal combining technology is MMSE diversity combining.

13. The apparatus of claim 9, wherein the channel demodulating component is further configured to detect a control value for the channel at least in part by comparing one or more detection thresholds to the channel, wherein the one or more detection thresholds are determined based at least in part on the signal combining component determining whether to utilize the signal combining technology combining the subsequently received signals.

14. The apparatus of claim 9, wherein the SINR measuring component is configured to measure based at least in part on determining whether antenna diversity is enabled at a multipath antenna over which the signal is received.

15. The apparatus of claim 9, wherein the signal is a pilot signal.

16. The apparatus of claim 9, wherein the channel is a media access control channel.

17. An apparatus for adaptive control channel detection in wireless communications, comprising:
means for measuring a signal-to-interference-and-noise ratio (SINR) of a signal received by a receiver comprising multiple sub-receivers, wherein the SINR is filtered according to a signal combining technology;
means for determining, based at least in part on the SINR, whether to utilize the signal combining technology in combining subsequently received signals related to a channel received over the multiple sub-receivers; and
means for demodulating the subsequently received signals related to the channel received over the multiple sub-receivers using the signal combining technology based on determining to utilize the signal combining technology.

18. The apparatus of claim 17, wherein the means for measuring further measures another SINR of the signal, wherein the another SINR is filtered for another selection combining technology, and wherein the means for determining determines whether to utilize the signal combining technology based at least in part on comparing the SINR to the another SINR to determine a difference relative to a threshold.

19. The apparatus of claim 18, wherein the signal combining technology is minimum mean squared error (MMSE) diversity combining, and the another signal combining technology is antenna selection combining.

20. The apparatus of claim 18, further comprising means for adaptively determining the threshold based at least in part on a minimum mean squared error (MMSE) combined noise standard deviation, wherein the signal combining technology is MMSE diversity combining.

21. The apparatus of claim 17, wherein the means for demodulating further detects a control value for the channel at least in part by comparing one or more detection thresholds to the channel, wherein the one or more detection thresholds are determined based at least in part on the means for determining determining whether to utilize the signal combining technology combining the subsequently received signals.

22. The apparatus of claim 17, wherein the means for measuring measures based at least in part on determining whether antenna diversity is enabled at a multipath antenna over which the signal is received.

23. The apparatus of claim 17, wherein the signal is a pilot signal.

24. A non-transitory computer-readable medium storing computer executable code for adaptive control channel detection, comprising:
code executable to measure a signal-to-interference-and-noise ratio (SINR) of a signal received by a receiver comprising multiple sub-receivers, wherein the SINR is filtered according to a signal combining technology;
code executable to determine, based at least in part on the SINR, whether to utilize the signal combining technology in combining subsequently received signals related to a channel received over the multiple sub-receivers; and
code executable to demodulate the subsequently received signals related to the channel received over the multiple sub-receivers using the signal combining technology based on determining to utilize the signal combining technology.

25. The non-transitory computer-readable medium of claim 24, further comprising code executable to measure another SINR of the signal, wherein the another SINR is filtered for another selection combining technology, wherein the code executable to determine determines whether to utilize the signal combining technology based at least in part on comparing the SINR to the another SINR to determine a difference relative to a threshold.

26. The non-transitory computer-readable medium of claim 25, wherein the signal combining technology is minimum mean squared error (MMSE) diversity combining, and the another signal combining technology is antenna selection combining.

27. The non-transitory computer-readable medium of claim 25, further comprising code executable to adaptively determine the threshold based at least in part on a minimum mean squared error (MMSE) combined noise standard deviation, wherein the signal combining technology is MMSE diversity combining.

28. The non-transitory computer-readable medium of claim 24, further comprising code executable to detect a control value for the channel at least in part by comparing one or more detection thresholds to the channel, wherein the one or more detection thresholds are determined based at least in part on the determining whether to utilize the signal combining technology combining the subsequently received signals.

29. The non-transitory computer-readable medium of claim 24, wherein the code executable to measure measures based at least in part on determining whether antenna diversity is enabled at a multipath antenna over which the signal is received.

30. The non-transitory computer-readable medium of claim 24, wherein the signal is a pilot signal.
